(19) United States
(12) Patent Application Publication
(10) Pub. No.: US 2005/0250667 A1
(43) Pub. Date: Nov. 10, 2005

(54) Effervescent granulated composition

(75) Inventors: Christian Quellet, Biel (CH); Thomas McGee, Nanuet, NY (US); Gerald Lesile Hart, Surbiton, Surrey (GB); Susan Hart, Surbiton (GB); Guy Edward Naish, Bicester Oxfordshire (GB); Marc Taschi, Zofingen (CH)

Correspondence Address: NORRIS, MCLAUGHLIN & MARCUS, 875 THIRD AVE, 18TH FLOOR, NEW YORK, NY, 10022, US

(73) Assignee: Givaudan SA, Vernier (CH)

(21) Appl. No.: 10/502,476

(22) PCT Filed: Jan. 22, 2003
(86) PCT No.: PCT/CH03/00046

§ 371 Date: Apr. 4, 2005

Related U.S. Application Data
(60) Provisional application No. 60/353,891, filed on Jan. 31, 2002.

(51) Int. Cl. C11D 17/00

(52) U.S. Cl. 510/444

(57) ABSTRACT

A cleansing product with an outstanding in-use performance comprising an excellent distribution of a detergent as well as an intensive fresh odour is provided by a product comprising a granulated composition consisting of a core material consisting of particles of a mixture of effervescent material and acid substance, said particles being dispersed within a matrix of non-aqueous binder material.

The present invention relates to a granulated composition comprising a component that has an effervescent action in water, and in particular such a composition that is stable at high storage temperatures, and to methods of forming same.

Granulated compositions containing an effervescing component are known for use on household surfaces, e.g. in toilets. Given that the activity of such compositions relies on their effervescing in the presence of moisture, a problem faced with such compositions is how to isolate them from moisture during storage and thereby improve their storage stability.

DE 198 47 283 describes an effervescent composition comprised of granules of effervescent materials, for use in washing applications. Granules are made by an agglomeration process using non-aqueous binding materials, e.g. certain polyethylene glycols. For stability and storage reasons, these compositions are provided in compact tablet form rather than free-flowing powders. By compressing the granules, it is considered more difficult for water to penetrate the granules. As such these compact forms are thought to be more stable than powders.

A problem with such formulations are that they do not reliably produce satisfactory effervescence in use because the disintegration and dissolution is retarded and is often incomplete.

For certain applications, in particular the cleaning of household surfaces, e.g. toilets it is highly desirable for effervescence to occur rapidly and vigorously in order to present the user with a strong visual and aural cue to the cleaning process. Further, vigorous effervescence will emit fragrance from the composition in a bursting manner which will further add to the perception of the user that the cleaning process is rapid and thorough.

Free-flowing granulated compositions are known which granules consist of a core material containing effervescent material and an acid substance, and surrounding the core is a layer of hydrated core material that forms a protective coating for the core material. Such granules are formed from an aqueous granulation process. They display the desired rapid and vigorous effervescence and are stable at normal storage temperatures. However, given that the granules are formed using water, it may be very difficult, time consuming and expensive to control processing conditions in order to exclude residual water from the granulated material. Accordingly, if too much residual water remains in the composition then under conditions of storage at elevated temperatures as may sometimes be experienced, e.g. at about 40-50 degrees centigrade or more, the composition may react with the residual moisture to produce emissions of gas.

There remains a need to provide a formulation that has the desired rapid and vigorous effervescence and which at the same time is stable during prolonged periods of storage even at temperature of about 40-50 degrees centigrade or more.

Surprisingly, the applicant has found a composition meeting these requirements. Therefore the invention provides in a first aspect a granulated composition comprising particles of a mixture of an effervescent material and an acid substance in a matrix of a non-aqueous binder material having a melting point in excess of 40-50 degrees centigrade.

The non-aqueous binder material is preferably a polymeric material that is non-tacky at elevated storage temperatures, e.g. about 40 degrees centigrade, but which possesses sufficient tack at processing temperatures to permit of rapid agglomeration of the particles referred to hereinabove. Still further, as the binder will be released into an aqueous environment in use, it is preferably water soluble at pH ranges that may be encountered having regard to the nature of the effervescent material and the acid substance. For these combination reasons it is preferably to employ a polyethyleneglycol (PEG), more particularly having a molecular weight of between 1000 and 12000. Other polymers may be used in admixture with the PEG, for example PVP, PVA, acrylates and biopolymers such as polysaccharides.

The non-aqueous binder material serves not only as a binder in the agglomeration of the particles to form the granulated compositions, it is also thought to improve the storage stability of the granulated composition by trapping and immobilising any entrained water, and preventing or retarding ingress of moisture into the particles. The stated usefulness of this material is in contradistinction to the teaching of DE 198 47 283. In this reference, whereas it is stated that one can employ a PEG in an agglomeration process, there is a prejudice against its use as it is consider to be disadvantageous in that it may interfere with the effervescence of the composition.

The non-aqueous binder may be present in the granulated composition in amounts of up to 10% by weight, more particularly 7 to 8% by weight.

As effervescent material, a variety of substances can be utilized. A requirement of the material is to effervesce in the presence of an aqueous acidic solution and an acidic substance. To mention a few examples, alkali metal carbonates (e.g. sodium bicarbonate, sodium sesquicarbonate, potassium bicarbonate, etc.) alkali metal hydrogen carbonates (e.g. sodium hydrogen carbonate, potassium hydrogen carbonate, etc.) and ammonium carbonate can be employed. These effervescent components can be used singly or in combination. Most preferred effervescent components are sodium carbonate and sodium hydrogen carbonate. The proportion of effervescent component can be selected from the range of 10-90% by weight of the composition.

The acid substance is such that it is a solid capable of reacting with the effervescent component in the presence of water to produce a gas. It may be any suitable organic, mineral or inorganic acid, or a derivative thereof, or a mixture thereof. The acid source may be a mono-, bi-, or tri-protonic acid. Said acid can be used in their protonized form or as salt thereof. The source of acidity is preferably non-hygroscopic, which can improve storage stability. The acid is preferably water-soluble. Suitable acids include citric, malonic, oxalic, glutaric, tantaric acid, succinic or adipic acid, monosodium phosphate, sodium hydrogen sulphate, boric acid, or a salt or an ester thereof, and sulphamic acid. Acidic substances may be employed in an amount of about 5% to about 70% by weight of the formulation. These acidic substances can also be used singly or in combination. A preferred mixture of acidic substances is formed by mixing citric and sulphamic acid, more preferred the ratio of citric to sulphamic acid is between 5:1 and 1:5, more preferably between 3:1 and 1:3, most preferably 1:1. This preferred mixture is particularly suitable for removing inorganic stains such as iron, manganese stains and limescale deposits, whilst maintaining optimum gas release and powder properties. Such compositions are particularly useful for toilet-cleaning operations.

The effervescent component and acid need not be present in equivalent amounts. The amount of each component necessary to generate a desired concentration of gas can easily be calculated by one of ordinary skill in the art based upon the stoichiometry of the ingredients chosen and the conditions under which they are expected to react.

The composition according to the present invention additionally comprises a detergent material. The purpose of the detergent is to stabilise gas bubbles generated as a result of the reaction of effervescent material and acid substance, which in turn is reflected in improved cleaning of surfaces to which the composition is applied. The detergent may be selected from the detergents selected from nonionic, anionic, cationic, and amphoteric surfactants.

Suitable anionic surfactants are, in particular, those of the sulphate and sulfonate type. The anionic surfactants are mainly used in the form of their sodium salts. Particularly suitable surfactants of the sulphate type are the sulphuric acid monoesters of primary alcohols of natural and synthetic origin, e.g. the sulphuric acid monoesters of fatty alcohols, for example cocofatty alcohols, tallow fatty alcohols, oleyl alcohol or C₁₀-C₂₀ oxo alcohols, and those of secondary alcohols with the same chain length. The sulphuric acid monoesters of aliphatic primary alcohols ethoxylated with 1 to 6 moles of ethylene oxide or ethoxylated secondary alcohols or alkylphenols may also be used.

The surfactants of the sulfonate type are, above all, the alkyl benzene sulfonates containing C₉-C₁₅ as alkyl groups and olefin sulfonates,e.g. mixtures of alkene and hydroxyalkane sulfonates and disulfonates of the type obtained, for example, from monoolefins with a terminal or internal double bond by sulfonation with gaseous sulphur trioxide and subsequent alkaline or acidic hydrolysis of the sulfonation products. Other useful surfactants of the sulfonate type are the alkane sulfonates obtainable from C₁₂-C₁₈ alkanes by sulfochlorination or sulfoxidation and subsequent hydrolysis or neutralization or by addition of bisulfites onto olefins and also the esters of alpha-sulfofatty acids, for example the alpha-sulfonated methyl- or ethyl-esters of hydrogenated coconut oil, palm kernel oil or tallow fatty acids.

Cationic surfactants useful in this invention include, e.g. quaternary ammonium compounds such as C₁₀-C₂₂ fatty ammonium compounds, C₁₀ to C₂₂ fatty morpholine oxides, propylene oxide condensates of C₁₀ to C₂₂ fatty acid monoesters of glycerins, the mono- or di-ethanol amides of C₁₀ to C₂₂ fatty acids, and alkoxylated siloxane compounds containing ethylene oxide units and/or propylene oxide units. As is known in the surfactant art, the counter-ion for cationic surfactants is usually a halide, sulphate, or methylsulfate, the chlorides being the most common industrially available compounds.

Other suitable cationic surfactants suitable for use in the present invention include straight chain alkyl fatty amines, alkyl-substituted quaternary ammonium salts, alkylaryl-substituted quaternary ammonium salts, quaternary imidazolinium salts, amine oxides, fatty amine oxides, trifatty amine oxides, triquaternary phosphate esters, amphoglycinate phosphates, amine acetates, long chain amines and their salts, diamines and their salts, polyamines and their salts, polyoxyethylenated long chain amines, and quaternized polyoxyethylenated long chain amines.

Examples of nonionic surfactants that can be employed are alkoxylated alkyl phenols, amides, amines, ethoxylated or propoxylated higher aliphatic alcohols, alkyl polyglucosides, alkyl polysaccharides and sulfonamides. These well known nonionic surfactants include sorbitan esters of C₁₀ to C₂₂ fatty acids, polyoxyethylene sorbitan esters of C₁₀ to C₂₂ fatty acids, polyoxyethylene sorbitol esters of C₀ to C₂₂ fatty acids, polyoxyethylene derivatives of C₆to C₂₀ fatty phenols, and polyoxyethylene condensates of C₁₀ to C₂₂ fatty acids or fatty alcohols. Polyoxyethylene and polyoxypropylene analogues of the above surfactants also can be used in the present invention.

Amphoteric surfactants useful in this invention generally include betaines, sultaines, and imidazoline derivatives. Specific amphoteric surfactants useful in this invention include ricinoleamidopropyl betaine, cocamidopropyl betaine, stearyl betaine, stearyl amphocarboxy glycinate, sodium lauraminopropionate, cocoamidopropyl hydroxy sultaine, disodium lauryliminodipropionate, tallowiminodipropionate, cocoamphocarboxy glycinate, cocoimidazoline carboxylate, lauric imidazoline monocarboxylate, lauric imidazoline dicarboxylate, lauric myristic betaine, cocoamidosulfobetaine, and alkylamidophospho betaine.

The choice of the detergents and their percentage content in the granulated composition according to the invention is determined by the intended cleaning performance and foaming characteristics desired. It may be preferable in certain embodiments of the present invention to include a mixture of surfactants. In all embodiments, the detergents selected should be effective to enhance formation of voluminous stable foam with the gas generated from the reaction of effervescent component and acid component, typically carbon dioxide gas. The detergents should be present in an amount of 0.1 to 30% by weight, preferably 0.5% to 8% by weight, more preferably 1% to 6% by weight, and most preferably 2% to 5% by weight.

Compositions according to the present invention may comprise optional ingredients such as antimicrobial agents and/or fillers and/or a fragrance and/or a drying agent and/or other ingredients such as dyes, builders, bleaches, enzymes, abrasive substances, or combinations thereof. Further, compositions according to the present invention may optionally comprise a “disintegrant”. The disintegrant increases the rate of dissolution of the granulated material in contact with water and speeds up foam formation. Typical disintegrants include synthetic polymers including, for example, poly(vinylpirrolidon), polyacrylates and polyvinylsulfonates, and native or modified biopolymers including alginates, starches, and cellulose, derivatives thereof and combinations thereof.

Useful optional ingredients are apparent to the skilled person and may be found in “Handbook of Pharmaceutical Excipients” by Ray C. Rowe, Pharmaceutical Press, and in “CRC Handbook of Food, Drug and Cosmetic Excipients” by Susan C. Smolinske, CRC Press.

When fragrances are employed, the vigorous and rapid liberation of gas causes the fragrance material to be carried away from the composition in a bursting manner to give the user a distinctive scent cue regarding the cleaning process. Various known fragrances may be employed depending on the type of smell which is to be imparted. The fragrance which can be of any type suitable for use in household cleaners can be included at any level between 0.1 and 10%, most preferably up to 5% and with a most preferred inclusion level of 0.25% to 5% by weight.

The term “builder” as used herein means an agent added to a composition in order to reduce the level of calcium in hard water. Suitable builders include calcium-binding substances, precipitants, calcium-specific ion exchangers and mixtures thereof. Examples of calcium-binding substances include alkali metal polyphosphates, such as sodium tripolyphosphate; nitrilotriacetic acid and water-soluble salts thereof; the alkali metal salts of carboxymethyloxysuccinic acid, ethylenediaminetetraacetic acid, oxydisuccinic acid, mellitic acid, benzopolycarboxylic acids. Examples of precipitants are sodium orthophosphate, sodium carbonate and soaps from long-chain fatty acids. Examples of calcium-specific ion exchangers are alkali metal aluminosilicates, e.g. sodium aluminosilicate. Builders are typically present at levels of up to 20% by weight, preferably 1% to 10% by weight of the composition.

As antimicrobial agents there may be mentioned compounds selected from the group of quaternary ammonium germicides, such as cetyl trimethyl ammonium bromide, alkyl aryl ammonium halides such as octadecyl dimethyl benzyl ammonium bromide, N-alkyl pyridinium halides such as N-cetyl pyridinium bromide. Other suitable types of quaternary ammonium germicides include those in which the molecule contains either amide, ether or ester linkages such as octyl phenoxy ethoxy ethyl dimethyl benzyl ammonium chloride,and N-(laurylcocoaminoformylmethyl)-pyridinium chloride. Other very effective types of quaternary ammonium germicides include those in which the hydrophobic radical is characterised by a substituted aromatic nucleus as in the case of lauryloxyphenyltrimethyl ammonium chloride, cetylaminophenyltrimethyl ammonium methosulfate, dodecylphenyltrimethyl ammonium methosulfate, dodecylbenzyltrimethyl ammonium chloride, and chlorinated dodecylbenzyltrimethyl ammonium chloride. They also include metal salts such as zinc citrate, zinc oxide, zinc pyrethiones, and octopirox; organic acids, such as sorbic acid, benzoic acid, and their salts; parabens, such as methyl paraben, propyl paraben, butyl paraben, ethyl paraben, isopropyl paraben, isobutyl paraben, benzyl paraben, and their salts; alcohols, such as benzyl alcohol, phenyl ethyl alcohol; boric acid; 2,4,4′trichloro-2-hydroxy-diphenyl ether; phenolic compounds, such as phenol, 2-methyl phenol, 4-ethyl phenol; essential oils such as rosemary, thyme, lavender, eugenol, geranium, tea tree, clove, lemon grass, peppermint, or their active components such as anethole, thymol, eucalyptol, farnesol, menthol, limonene, methyl salicylate, salicylic acid, terpineol, nerolidol, geraniol, and mixtures thereof.

The composition according to the invention may contain abrasive particles. The choice is not limited and any suitable particles of appropriate particle size and abrasivity may be used. Examples of suitable abrasive particles include calcium carbonate, pumice stone, calcite, dolomite, feldspar, talc, alumina, silica, quartz, perlite, zirconium silicate and diatomaceous earth and organic materials such as melamine, resins such as urea formaldehyde resins, polyethylene beads and polyamide derivatives or any other substance that is commonly used as an abrasive particle but does not result in the generation of noxious gases, such as sulphur dioxide, on contact with water. The abrasive particles may be present in amounts of up to 30%, most preferably 2% to 15% by weight of the composition.

The composition according to the present invention may additionally comprise a bleach and/or a bleach activator. Such bleaches include, for example, perborates, percarbonates, persilicates, perphosphates, and mixtures thereof. Bleach activators may be compounds having quaternary ammonium structures, such as, for example, 2-(N,N,N-triethylammonio)ethyl 4-sulfophenyl carbonate, N-octyl-N,N-dimethyl-N-10-carbophenoxydecylammonium chloride, sodium 3-(N,N,N-trimethylammonio)-propyl 4-sulfobenzoate and N,N,N-trimethylammonium tolyl-oxybenzenesulfonate. Another class of bleach activators are esters such as, for example, acylphenolsulfonates and acylalkylphenolsulfonates and acylamides. Most preferred are sodium 4-benzoyloxybenzenesulfonate, N,N,N′,N′-tetraacetylethylenediamine (TAED), sodium 1-methyl-2-benzoyloxybenzene4-sulfonate, sodium 4-methyl-3-benzoyloxybenzoate, sodium nonanoyloxybenzenesulfonate, sodium 3,5,5-trimethylhexanoyloxybenzenesulfonate, benzoylcaprolactam, 2-phenyl-4H-3,1-benzoxazin-4-one, glucose pentaacetate and tetraacetylxylose and also ketones and nitrilic activators. Optionally bleach activators may include for example transition metal salts and corresponding complexes with, e.g. chelating compounds. Chlorine bleaches may be used and include, for example, chlorinated isocyanuric acids and salts thereof include dichloroisocyanuric acid, trichloroisocyanuric acid, or alkali metal salts thereof such as sodium dichloroisocyanurate in either granular or powdered form or combinations thereof. Any reference to such salts herein, whether specific or in general, refers to both the anhydrous form as well as any hydrates thereof.

The composition according to the present invention may further comprise enzymes.

Enzymes may be lipase enzymes for the degradation of oleaginous materials such as fats, greases and oils, protease enzymes to degrade proteins and amylase enzymes to degrade starch and mixtures thereof.

A drying agent may be added to assist in the prevention of caking and of the liberation of free hydrogen ions. Examples of drying agents are, without limiting the process of the invention to these examples, activated aluminium oxide, barium oxide, calcium oxide, calcium chloride, calcium sulphate, lithium chloride, sodium sulphate, magnesium sulphate, magnesium chloride, and natural or synthetic hydrophilic aluminosilicates of the zeolite type. The drying agent may be present in amounts of up to 20% by weight of the composition.

A dye or colorant is also preferably included at concentrations up to 3% by weight, preferably up to 0.3% by weight. The amount of colouring agents or dyes to be dispensed into the water will depend on the colour intensity desired and the cost of the dye. The choice of the colouring agent will largely depend on the colour desired for the water into which the powder is to be dispensed. A preferred colouring agent is FD & C Blue 1.

As fillers there may be mentioned those well know to those skilled in the art. The fillers function as materials which comprise part of the formula as non-functional bulking agents. Examples for fillers are alkaline earth metal salts of sulphates, e.g. sodium sulphate, and chlorides

Other optional ingredients such as soil release polymers, brightening agents, anti-redeposition agents, starches and other binders and such like as those skilled in the art may consider can be incorporated.

The granulated composition as hereinabove described are conveniently formed as granules containing both effervescent material and acid substance, detergent and other optional ingredients. However, alternative embodiments also fall within the scope of the present invention, for example, the granulated composition may consist of first and second granules, wherein first granules contain the effervescent material but no acid substance, and second granules contain acid substance but no effervescent material. Other ingredients, such as detergent and optional others may be present in said first or second granules or both as convenient having regard to such considerations as compatibility and the ease of admixture of the ingredients. Still further, said first and second granules may by stored in admixture or they may be stored separately and only mixed together shortly before use.

In another aspect of the present invention there is provided a method of producing a composition as hereinabove defined comprising the steps of mixing and optionally milling an effervescent material, an acid substance and a detergent and any of the optional ingredients defined hereinabove, and thereafter fluidising the resultant mixture on a fluidised bed reactor with a non-aqueous binder. All ingredients to be used are dry, that is, essentially free of non-chemically bound water, e.g. having less than 0.5% by weight non-chemically bound water, and preferably are all solids with the exception of the fragrance. The resulting mixture is a powder. The mixture is heated to a temperature of 30 to 50° C., such that the temperature is approximately 10° C. below the solidification temperature of the binder melt. The binder is introduced at temperatures from ambient up to 140° C., preferably 80 to 120° C. after fluidising the resulting mixture. The amount of binder added in the fluidised bed is preferably approximately 5 to 10% by weight of the resulting mixture. Once the agglomeration of particles reaches the desired average size of 0.1 to 5 mm, preferably 0.5 to 3 mm, then the introduction of binder is terminated and dry cold air is introduced to cool down the product. The moisture content of the agglomerated granule is preferably less than 2% by weight.

Any apparatus providing a fluidised bed and a means to introduce atomised binder can be used to carry out this process, e.g. GPC supplied by Glatt. Other suppliers for fluid bed agglomerators are, e.g. Eurovent Ltd. And Allgaier GmbH. Alternatively, a batch or continuous mechanically generated fluidised bed mixer operating on the so-called ‘hurling and whirling’ principle can be employed, for example a Lödige Ploughshare mixer type FKM or KM.

In another embodiment of the process described above the agglomeration compositions may be post-dosed with fragrance, for example by introducing a fragrance on to the fluidised bed after the agglomeration process is finalised, or spraying on in a separate mixer. Preferably, only up to 5% (w/w) fragrance, more preferably up to 3%, may be post-dosed to ensure that the protecting layer is not compromised.

If the granulated composition is provided in a two-part form consisting of first and second granules as described above, the agglomeration process may be carried out to form first granules and second granules in a manner analogous to that described above.

The composition of the present invention may be used as household and industrial products for a variety of cleaning purposes such as cleaning hard surfaces. Said compositions are particularly suitable in the cleaning of inclined surfaces including toilet bowls, basins, lavatories and surfaces in the kitchen.

The composition according to the present invention may be contained in a dispenser that is designed to allow the composition to be poured onto the surface to be cleaned, or in a container which has a system that will measure out a unit dose prior to pouring onto the surface to be cleaned.

In another embodiment the composition may be contained in a water-soluble sachet, such as a polyvinylalcohol sachet, which can then be introduced into water as a measured dose. Alternatively, it may be contained in a water-insoluble plastic or laminated sachet, which sachet may be torn and the contents poured onto the area to be cleaned. Still further, the composition may be contained in a pad, either by sealing it between two layers or in sealed pockets, which can be moistened to generate the release of actives for cleaning a surface. In a further embodiment the granulated composition according to the invention may be formed into tablets by compressing it in an appropriate manner.

The following examples illustrate compositions according to the present invention. The exemplified compositions are illustrative only and do not limit the scope of the invention.

### EXAMPLE 1

### Method of Manufacture

A fluid-bed dryer (87 litre capacity) was pre-heated to 55 degrees centigrade. The ingredients set forth in the Examples 2 and 3 respectively were mixed and milled to form a homogenous powder. The milled, mixed powder was vacuum transferred to the fluid-bed dryer. This transfer was made through a spray inlet. In this manner 20 kg of powder was placed in the bed. The spray nozzle was adjusted to ensure that the introduction of the binder was 130 ml/min and atomised to 2 bar (external). The inlet air temperature was set to 55 degrees centigrade, and the temperature of the powder was raised to 30 degrees centigrade. Once the powder reached this temperature, the binder was sprayed onto the powder. 2.5 litres of binder were sprayed in this manner over about a 20 minute period. The sprayer was then turned off and the resultant coated powder was cooled in an air stream (at ambient temperature) until the product temperature reached 25 degrees centigrade. The resultant product was removed from the bed.

### EXAMPLE 2

| Core material | |
|---|---|
| Citric acid (anhydrous) | 34.2 |
| Sodium bicarbonate | 34.5 |
| Sulphamic acid | 12.1 |
| Sodium lauryl sulphate | 4.5 |
| Cetyl trimethylammonium bromide | 1.8 |
| Magnesium sulphate | 4.5 |
| Binder Material | |
| PEG 1500 | 4.2 |
| PEG 4000 | 4.2 |

The granules formed according to the procedure of Example 1 were cooled and placed in a laminated pouch and stored in ovens at 40 degrees centigrade. No signs of gas generation were noted during a 1 month period.

1. Granulated composition comprising particles containing a mixture of an effervescent material and an acid substance in a matrix of a non-aqueous binder material, the binder material having a melting point in excess of 40 degrees centigrade.

2. Granulated composition according to claim 1 wherein the non-aqueous binder comprises a polyethylene glycol.

3. Granulated composition according to claim 2 wherein the polyethylene glycol is selected from PEG 1500 to PEG 12000.

4. Granulated composition according to claim 1 wherein the binder is present at levels of up to 10% (wt) of the composition.

5. Granulated composition according to claim 1 wherein the effervescent component is selected of the group of sodium bicarbonate, sodium sesquicarbonate, potassium bicarbonate and potassium carbonate.

6. Granulated composition according to claim 1 wherein the acidic substance is selected of the group of citric acid, oxalic acid, malonic acid, succinic acid, adipic acid, sulphamic acid, and the corresponding salt of said acid.

7. Granulated composition according to claim 6, wherein the acidic substance is a combination of citric acid and sulphamic acid.

8. Granulated composition according to claim 7, wherein the ratio of citric acid to sulphamic acid is between 5:1 and 1:5, more preferably between 3:1 and 1:3, most preferably between 1:1.

9. Granulated composition according to claim 1 comprising 10 to 90% by weight of the effervescent component.

10. Granulated composition according to claim 1 comprising 5 to 70% by weight of an acidic substance.

11. Granulated composition according to claim 1 additionally comprising a detergent.

12. Granulated composition according to claim 11 comprising 0.1 to 30% by weight of a detergent.

13. Granulated composition according to claim 1 additionally comprising at least one of the following: a fragrance, a drying agent, and an abrasive substance.

14. Granulated composition according to claim 1 having a particle size of 0.1 to 5 mm.

15. Household products comprising a granulated composition according to claim 1.

16. Industrial products comprising a granulated composition according to claim 1.

17. A method for producing a granulated composition comprising the steps of mixing a composition comprising an effervescent component, acid substance, detergent and other optional ingredients and thereafter fluidising the mixture on a fluidised bed with a binder material.
